(19) United States
(12) Patent Application Publication
(10) Pub. No.: US 2024/0289171 A1
(43) Pub. Date: Aug. 29, 2024

(54) METHOD AND OPTICAL NETWORK UNIT ROUTER FOR MEMORY ACCESS CONTROL

(71) Applicant: Airoha Technology (Suzhou) Limited, Suzhou City (CN)

(72) Inventors: Weihua HUANG, Nanjing (CN); Fei YAN, Nanjing (CN)

(73) Assignee: Airoha Technology (Suzhou) Limited, Suzhou City (CN)

(21) Appl. No.: 18/368,906

(22) Filed: Sep. 15, 2023

(30) Foreign Application Priority Data
Feb. 24, 2023 (CN) 202310160724.1

(51) Int. Cl. G06F 9/50

(52) U.S. Cl. CPC G06F 9/5038; G06F 9/5016; G06F 9/5072; G06F 2209/5011

(57) ABSTRACT

The invention relates to a method, a non-transitory computer-readable storage medium and an optical network unit (ONU) router for memory access control. The method, which is performed by a central processing unit (CPU), includes: obtaining an identification of a core; determining one from multiple allocated queues according to the identification of the core; and dequeuing one or more items in a shared resource pool starting from a slot that is pointed to by a take index, and enqueuing the one or more items into the determined allocated queue starting from an empty slot that is pointed to by a write index. Each item stored in the determined allocated queue includes a memory address range of a random access memory (RAM), so that the memory address range of the RAM has been reserved for the first core.

### CROSS-REFERENCE TO RELATED APPLICATIONS

This application claims the benefit of priority to Patent Application No. 202310160724.1, filed in China on Feb. 24, 2023; the entirety of which is incorporated herein by reference for all purposes.

### BACKGROUND

The disclosure generally relates to memory management and, more particularly, to a method, a non-transitory computer-readable storage medium and an optical network unit (ONU) router for memory access control.

The network processing unit (NPU) is an integrated circuit, which can be programmed by software, and is dedicated in the networking equipment. An algorithm which runs on the NPU mainly includes varies functions of data packet processing for repeatedly receiving packets through one port, decapsulating packets in conformity to the reception protocol, processing data from the decapsulated ones, encapsulating the processed data into packets in conformity to the transmission protocol, and transmitting the data packets out through another port. As network applications become more and more diverse, and the amount of transmitted data become larger and larger, single-core NPUs cannot meet the requirements of data processing speed, thus, more and more network devices are equipped with a multi-core NPU to perform various tasks of packet processing and forwarding. However, the parallel execution of multi-core NPUs would result in contenting among cores for shared memory, thereby degrading the overall performance of network devices. Therefore, how to solve the contention conflict of the shared memory among the cores to improve the overall system performance is an important issue at present.

### SUMMARY

The disclosure relates to an embodiment of a method for memory access control, which is performed by a central processing unit (CPU), includes: obtaining an identification of a core that requests to allocate memory space; determining one from multiple allocated queues according to the identification of the core; and dequeuing one or more items in a shared resource pool starting from a slot that is pointed to by a take index, and enqueuing the one or more items into the determined allocated queue starting from an empty slot that is pointed to by a write index. Each item stored in the determined allocated queue includes a memory address range of a random access memory (RAM), so that the memory address range of the RAM has been reserved for the first core.

The disclosure further relates to an embodiment of a non-transitory computer-readable storage medium having stored therein program code that, when loaded and executed by a CPU, causes the CPU to perform the above method for memory access control.

The disclosure further relates to an embodiment of an optical network unit (ONU) router for memory access control to include a NPU; a RAM and a CPU. The NPU includes multiple cores. The RAM includes a shared resource pool and multiple allocated queues. The CPU is arranged operably to: obtain an identification of a core that requests to allocate memory space; determine one from the allocated queues according to the identification of the core; and dequeue one or more items in the shared resource pool starting from a slot that is pointed to by a take index, and enqueue the one or more items into the determined allocated queue starting from an empty slot that is pointed to by a write index.

The disclosure relates to an embodiment of a method for memory access control, applied in a multi-core NPU including a first core and a second core, includes: in response to the first core requesting memory space allocation, providing an item from an allocated queue dedicated to the first core to the first core, where the first allocation queue cannot be used by the second core; and accessing, by the first core, to memory space indicated by a memory address range recorded in the item.

Both the foregoing general description and the following detailed description are examples and explanatory only, and are not restrictive of the invention as claimed.

### BRIEF DESCRIPTION OF THE DRAWINGS

FIG. 1 is a schematic diagram of a memory access control according to some implementations.

FIG. 2 is a schematic diagram illustrating a passive optical network (PON) according to an embodiment of the present invention.

FIG. 3 is the system architecture of an Optical Network Unit (ONU) router according to an embodiment of the present invention.

FIG. 4 is a schematic diagram of a shared resource pool and three pairs of allocated queue and recycled queue according to an embodiment of the present invention.

FIG. 5 is a schematic diagram of a proxy mechanism according to an embodiment of the present invention.

FIG. 6 is a flowchart illustrating a method for allocating memory space according to an embodiment of the present invention.

FIG. 7 is a schematic diagram for initializing the proxy mechanism according to an embodiment of the present invention.

FIG. 8 is a schematic diagram for obtaining a memory address range according to an embodiment of the present invention.

FIG. 9 is a schematic diagram for requesting to allocate memory address ranges according to an embodiment of the present invention.

FIG. 10 is a schematic diagram for releasing memory address ranges according to an embodiment of the present invention.

FIG. 11 is a flowchart illustrating a method for recycling memory space according to an embodiment of the present invention.

FIG. 12 is a schematic diagram for recycling memory address ranges that have been allocated according to an embodiment of the present invention.

### DETAILED DESCRIPTION

Reference is made in detail to embodiments of the invention, which are illustrated in the accompanying drawings. The same reference numbers may be used throughout the drawings to refer to the same or like parts, components, or operations.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words described the relationship between elements should be interpreted in a like fashion (e.g., “between” versus “directly between,” “adjacent” versus “directly adjacent.” etc.)

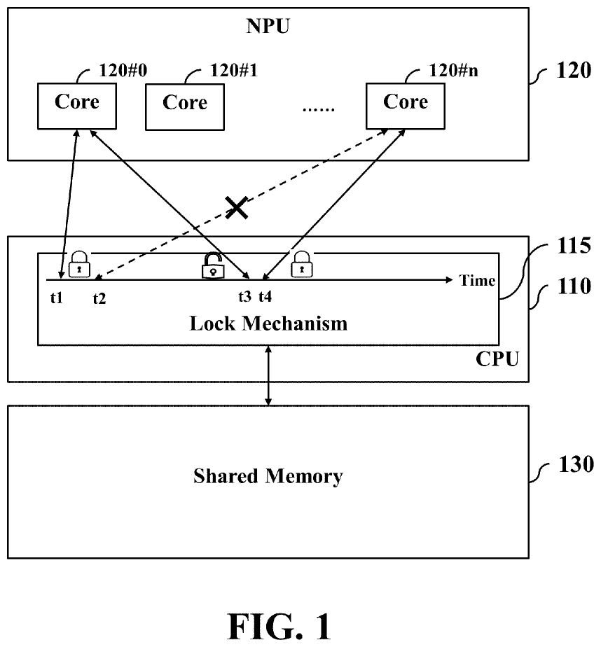

Refer to FIG. 1 showing a schematic diagram of memory access control according to some implementations. Current network devices are usually equipped with both the central processing unit (CPU) 110 and the network processing unit (NPU) 120 and the two sorts of processors are responsible for performing different tasks. The NPU 120 is a processor, which can be programmed by software, and is dedicated to process and forward different types of packets for providing a more efficient and flexible packet processing solution. As network applications become more and more diverse, and the amount of transmitted data becomes larger and larger, single-core NPU cannot meet the requirements of data processing speed, so increasing network devices are equipped with the multi-core NPU 120 to perform various packet processing and forwarding. However, the parallel execution of multi-core NPU 120 would result in contenting among cores for the shared memory 130. The shared memory 130 may be a static random access memory (SRAM), a dynamic random access memory (DRAM), or the combination. In order to solve the contention conflict of the shared memory among the cores, in some implementations, the CPU may perform the lock mechanism 115 to handle the parallel accesses by the cores 120 #0 to 120 #n to the shared memory 130. For example, the core 120 #0 can freely read data from the shared memory 130 and store data in the shared memory 130 after the lock mechanism 115 permits the core 120 #0 to lock the shared memory 130 at the time point t1. If the core 120 #n requests to lock the shared memory 130 at the time point t2, since the shared memory 130 has already been locked by the core 120 #0, the lock mechanism 115 rejects the core 120 #n. The lock mechanism 115 makes the shared memory 130 enter the unlocked state after the core 120 #0 releases the shared memory 130 at the time point t3, so that the core 120 #n can lock the shared memory 130 at the time point t4 successfully to perform data access thereto. However, the lock mechanism 115 would cause any core in the NPU 120 to spend time waiting for other cores to release the shared memory 130 to perform data access, reducing the overall performance of the network devices.

To address the problems as described above, an embodiment of the present invention introduces a method for data access control to avoid unnecessary waiting time for the cores in the NPU due to the locked shared memory 130, thereby improving the overall performance of multi-core NPU 120. Although the specification describes the shortcomings of the above implementation, this is only used to illustrate the inspiration of the embodiments of the present invention. Those artisans can apply the technical solutions as follows to solve other technical problems or be applicable to specific technical environments, and the invention should not be limited thereto.

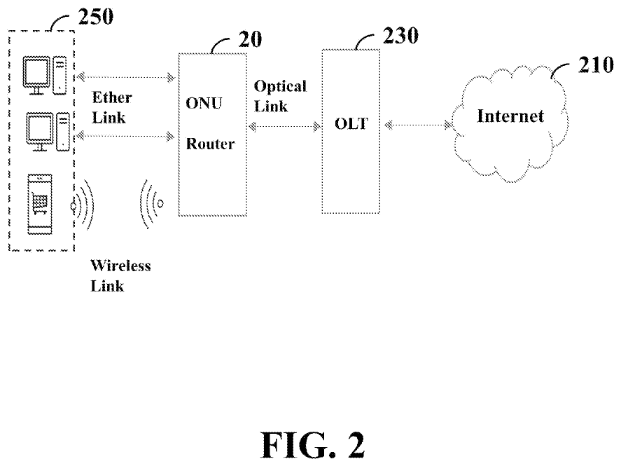

In some embodiments, the method for memory access control may be applied in Optical Network Units (ONUs). Refer to FIG. 2 showing a schematic diagram of a passive optical network (PON). The PON consists of the optical line terminal (OLT) 230 at the service provider's central control room, and a number of optical network units (ONUs), such as the ONU router 20. The OLT 230 provides two main functions: to perform conversion between the electrical signal used by the service provider's equipment and the fiber-optic signal used by the PON; and to coordinate the multiplexing between the ONUs on the other end of the PON. The OLT 230 and the ONU router 20 are connected to each other by an optical link. The ONU router 20 is a user-end equipment of the PON system, which can be installed in a home for interconnection with the user devices 250 using ether links, wireless links or the both. The user device 250 may be a Personal Computer (PC), a laptop PC, a tablet PC, a mobile phone, a digital camera, a digital recorder, a smart television, a smart air conditioner, a smart refrigerator, a smart range hood, or other consumer electronic products. With the collocation of the OLT 230, the ONU router 20 provides various broadband services to the connected user devices 250, such as Internet surfing, Voice over Internet Protocol (VoIP) communications, high-quality video, etc.

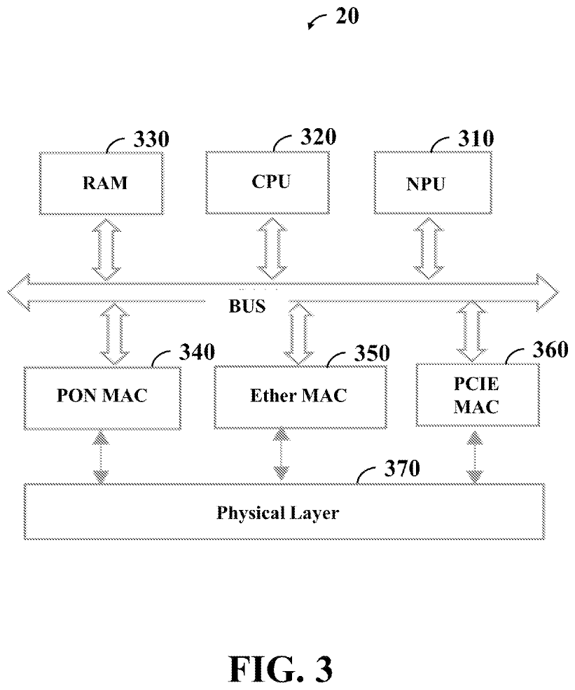

Refer to FIG. 3 showing the system architecture of the ONU router 20. The ONU router 20 includes the multi-core NPU 310, the Central Processing Unit (CPU) 320, the Random Access Memory (RAM) 330, the PON Media Access Control (MAC) 340, the Ether MAC 350, the Peripheral Component Interconnect Express (PCIE) MAC 360, which are coupled to each other by the shared bus architecture. The shared bus architecture facilitates the transmissions of data, addresses, control signals, etc. between the above components. The bus architecture includes a set of parallel physical-wires and is a shared transmission medium so that only two devices can access to the wires to communicate with each other for transmitting data at any one time. Data and control signals travel bidirectionally between the components along data and control lines, respectively. Addresses on the other hand travel only unidirectionally along address lines. For example, when the NPU 310 prepares to read data from a particular address of the RAM 330, the NPU 310 sends this address to the RAM 330 through the address lines. The data of that address is then returned to the NPU 310 through the data lines. To complete the data read operation, control signals are sent along the control lines.

The CPU 320 may be implemented in numerous ways, such as with general-purpose hardware (e.g., a single processor, multiple processors or graphics processing units capable of parallel computations, or others) that is programmed using software instructions to perform the functions recited herein. The multi-core NPU 310 includes one or more integrated circuits (ICs) and each core has a feature set specifically targeted at the networking application domain. The multi-core NPU 310 is a software programmable device and has generic characteristics similar to general purpose processing unit that are commonly used in processing packets interchanged between different types of networks, such as PON, Ethernet, Wireless Local Area Network (WLAN), Personal Access Network (PAN), and the like, for improving the overall performance of ONU router 20. The RAM 330 allocates space as a data buffer for storing messages that are received through ports corresponding to different types of networks, and are to be sent out through ports corresponding to different types of networks. The RAM 330 further stores necessary data in executions by the multi-core NPU 310, such as variables, flags, data tables, and so on. The RAM 330 may be implemented by a dynamic random access memory (DRAM), a static random access memory (SRAM) or the both. The PON MAC 340 is coupled to a corresponding circuitry of the physical layer 370 for driving the corresponding circuitry (may include an optical receiver and an optical transmitter) to generate a series of optical signal interchanges with the OLT 230, so as to receive and transmit packets from and to the OLT 230 through the optical link. The Ether MAC 350 is coupled to a corresponding circuitry of the physical layer 370 for driving the corresponding circuitry (may include a digital receiver and a digital transmitter) to generate a series of electrical signal interchanges with the user device 250, so as to receive and transmit packets from and to the user device 250 through the Ether link. The PCIE MAC 360 is coupled to a corresponding circuitry of the physical layer 370 for driving the corresponding circuitry (may include a radio frequency (RF) receiver and an RF transmitter) to generate a series of RF signal interchanges with the user device 250, so as to receive and transmit packets from and to the user device 250 through the wireless link. The wireless link may be established with a wireless communications protocol, such as 802.11x, Bluetooth, etc.

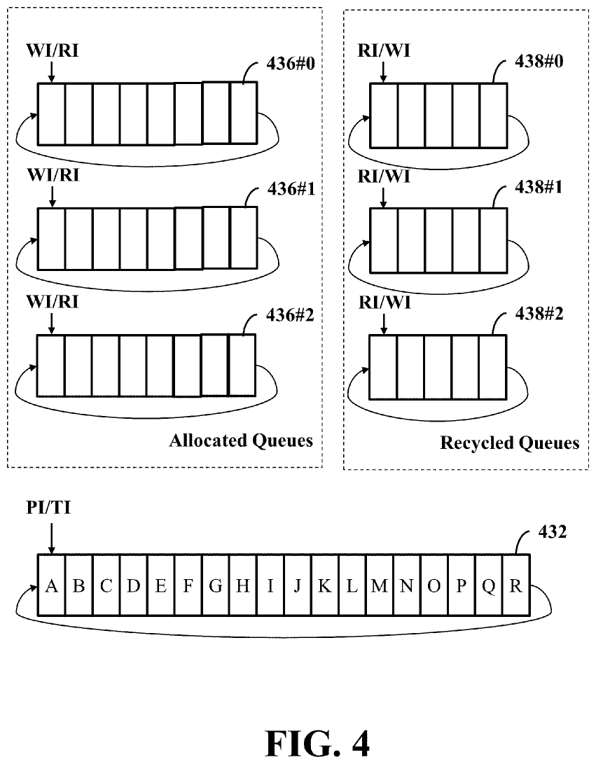

To address the contention conflicts among cores for the shared memory, an embodiment of the present invention introduces a proxy mechanism rather than the lock mechanism as described above. Refer to FIG. 4. In order to allow the proxy mechanism to operate, for example, spaces of the RAM 330 are allocated for the shared resource pool 432 and three pairs of allocated queues 436 #0 to 436 #2 and recycled queues 438 #0 to 438 #2. The shared resource pool 432 may be implemented as a cyclical queue including multiple slots, and each slot may be an empty slot or include an item, which stores information about an address range corresponding to available space allocated to the NPU 310 in the RAM 330. Each of the items stored in the shared resource pool 432 may be referred to as an available item, and the memory address ranges stored in arbitrary two available items are not overlapped.

For example, in FIG. 4, the 0^{th} item of the shared resource pool 432 stores the address range 0x10000000-0x1000FFFF (denoted as “A”), the 1st item of the shared resource pool 432 stores the address range 0x10010000-0x1001FFFF (denoted as “B”), the 2^{nd} item of the shared resource pool 432 stores the address range 0x10020000-0x1002FFFF (denoted as “C”), and so on. In the example of FIG. 4, each slot in the shared resource pool 432 includes one item.

The shared resource pool 432 may use the put index (denoted as “PI”) to complete the enqueue operation and use the take index (denoted as “TI”) to complete the dequeue operation. Except for the case where the put index PI and the take index TI point to the same slot, the slot pointed to by the take index TI contains one item and the slot pointed to by the put index PI is an empty slot.

When there is still an empty slot in the shared resource pool 432, the CPU 320 can add an item to the empty slot that is indicated by the put index PI in the shared resource pool 432 (also called enqueuing), and move the put index PI to point to the next slot. If the next slot exceeds the last slot of the shared resource pool 432, the updated put index PI points to the first slot of the shared resource pool 432. If the updated put index PI points to the same slot pointed by the take index TI, then the shared resource pool 432 has no empty slot.

When the shared resource pool 432 is not an empty queue, the CPU 320 can remove the item indicated by the take index TI from the shared resource pool 432 (also called dequeuing), and move the take index TI to the next slot. If the next slot exceeds the last slot of the shared resource pool 432, the updated take index TI points to the first slot of the shared resource pool 432. If the updated take index TI points to the same slot pointed by the put index PI, then the shared resource pool 432 becomes an empty queue.

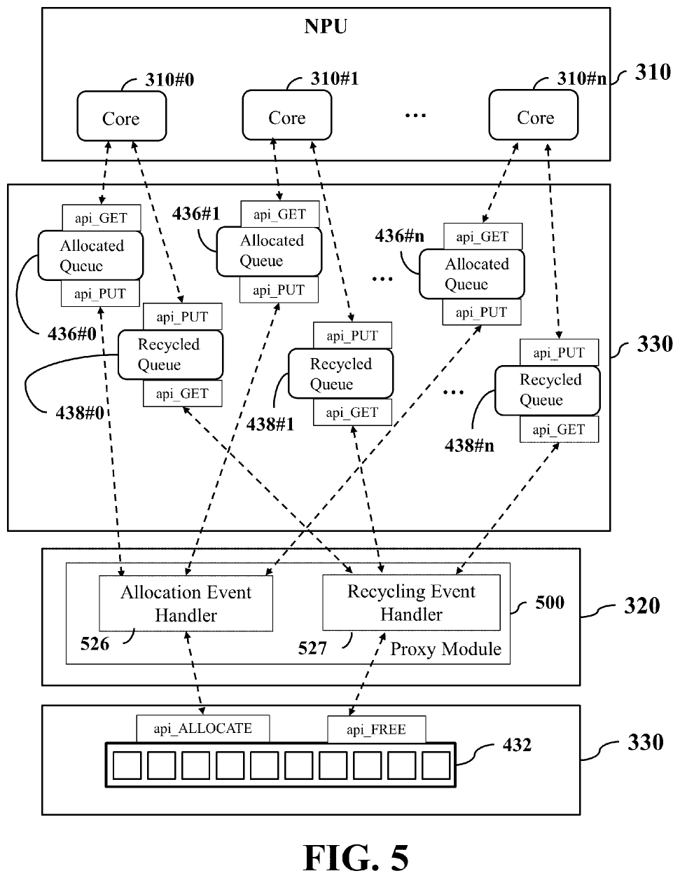

Each pair of allocated queue and recycled queue is assigned to a designated core, so that one pair of allocated queue and recycled queue can be used by one core only. For example, the allocated queue 436 #0 and the recycled queue 438 #0 are set to the core 310 #0 (as shown in FIG. 5), the allocated queue 436 #1 and the recycled queue 438 #1 are set to the core 310 #1 (as shown in FIG. 5), and so on. Each of the allocated queues and recycled queues may be implemented as a cyclical queue.

The allocated queue 436 (representing any of the allocated queues 436 #0 to 436 #3) includes multiple slots, and each slot may be an empty slot or include one item, which stores an available address range in the RAM 330 reserved for the corresponding core. For example, each item in the allocated queue 436 #0 stores an available address range in the RAM 330 reserved for the core 310 #0, each item in the allocated queue 436 #1 stores an available address range in the RAM 330 reserved for the core 310 #1, and so on.

Each allocated queue may use the write index (denoted as “WI”) and the read index (denoted as “RI”) to complete the enqueuing and the dequeuing operations, respectively. Except for the case where the write index WI and the read index RI point to the same slot, the slot pointed to by the read index RI contains one item and the slot pointed to by the write index WI is an empty slot. The enqueuing and dequeuing operations of the allocated queue 436 are similar with that of the shared resource pool 432, and are not repeated herein for brevity.

The recycled queue 438 (representing any of the recycled queues 438 #0 to 438 #3) includes multiple slots, and each slot may be an empty slot or include one item, which stores an address range in the RAM 330 that has been released by the corresponding core. For example, each item in the recycled queue 438 #0 stores an address range in the RAM 330 that has been released by the core 310 #0, each item in the recycled queue 438 #1 stores an address range in the RAM 330 that has been released by the core 310 #1, and so on.

Each recycled queue may use the write index (denoted as “WI”) and the read index (denoted as “RI”) to complete the enqueuing and the dequeuing operations, respectively. Except for the case where the write index WI and the read index RI point to the same slot, the slot pointed to by the read index RI contains one item and the slot pointed to by the write index WI is an empty slot. The enqueuing and dequeuing operations of the recycled queue 438 are similar with that of the shared resource pool 432, and are not repeated herein for brevity.

In addition to the shared resource pool 432, the allocated queue 436 and the recycled queue 438, refer to FIG. 5 showing a schematic diagram of the proxy mechanism. The CPU 320 executes program code of the proxy module 500 to manage shared storage resources. The proxy module 500 provides application programming interfaces (APIs) for the shared resource pool 432, the allocated queue 436 and the recycled queue 438.

APIs provided for the shared resource pool 432 include: “api_ALLOCATE”; and “api_FREE”. API “api_ALLOCATE” is used to fetch a specific number of items from the shared resource pool 432 starting from the slot that is pointed to by the take index TI, and update the take index TI to point to the slot next to the last fetched item. API “api_FREE” is used to store a specific number of items in the shared resource pool 432 starting from the empty slot pointed to by the put index PI, and update the put index PI to point to the empty slot next to the last stored item.

APIs provided for the allocated queue 436 include: “api_GET”; and “api_PUT”. API “api_GET” is used to fetch a specific number of items from the allocated queue 436 starting from the slot that is pointed to by the read index RI, and update the read index RI to point to the slot next to the last fetched item. API “api_PUT” is used to store a specific number of items in the allocated queue 436 starting from the empty slot pointed to by the write index WI, and update the write index WI to point to the empty slot next to the last stored item.

APIs provided for the recycled queue 438 include: “api_GET”; and “api_PUT”. API “api_GET” is used to fetch a specific number of items from the recycled queue 438 starting from the slot that is pointed to by the read index RI, and update the read index RI to point to the slot next to the last fetched item. API “api_PUT” is used to store a specific number of items in the recycled queue 438 starting from the empty slot pointed to by the write index WI, and update the write index WI to point to the empty slot next to the last stored item.

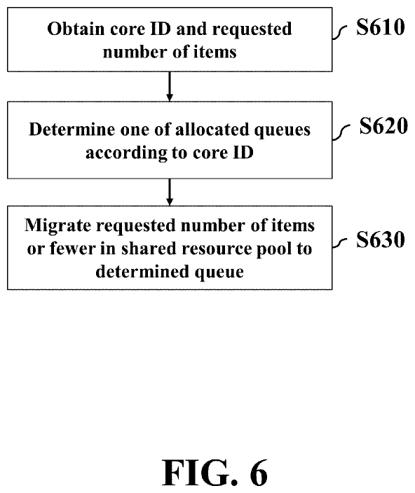

The proxy module 500 centrally assigns the shared storage resources (e.g. available space in the RAM 330 allocated for the NPU 310) to multiple cores 310 #0 to 310 #n in the NPU 310, where n is an amount of cores minus one. The proxy module 500 includes the allocation event handler 526 and provides an allocation event that can be triggered by any other process of the proxy module 500, or a process running on any core. In addition to triggering the allocation event, the process can also take parameters into the allocation event to provide the core identification (ID) and the requested number of items. The CPU 320 when detecting the allocation event executes program code of the allocation event handler 526 to migrate one or more items in the shared resource pool 432 to the corresponding one of the allocated queues 436 #0 to 436 #n, which means that a portion of space in the RAM 330 has been reserved for the corresponding core, according to the parameters input through the APIs “api_ALLOCATE” and “api_PUT”. It is to be noted here that the memory address range of any item in the allocated queue 436 is only reserved in advance for the corresponding core, so that the corresponding core can be used when necessary in other process after the execution of the allocation event handler 526, and it does not mean that it has been used by the corresponding core. If the corresponding core needs to use any memory address range stored in the item(s), other process needs to be executed to fetch the corresponding item from the allocated queue 436 through the API “api_GET”, so as to use the memory address range of the fetched item. Refer to FIG. 6 illustrating a method for allocating memory space, performed by the CPU 320 when loading and executing program code of the allocation event handler 526. The details are as follows:

Step S610: The core ID and the requested number of items are obtained from the input parameters.

Step S620: One of the allocated queues is determined according to the core ID. For example, the allocated queue 436 #0 is determined if the core ID is the ID of the core 310 #0, the allocated queue 436 #1 is determined if the core ID is the ID of the core 310 #1, and so on.

Step S630: The requested number of items or the fewer in the shared resource pool 432 are migrated to the determined queue. For example, assume that the requested number of items is two: However, the allocation event handler 526 only fetches one item (e.g. the 0^{th} item) from the shared resource pool 432 starting from the slot that is pointed to by the take index TI through the API “api_ALLOCATE”, and stores the fetched item in the allocated queue 436 #0 starting from the empty slot that is pointed to by the write index WI through the API “api_PUT”, which means that the proxy module 500 assigns the address range “0x10000000-0x1000FFFF” of the RAM 330 to the core 310 #0. In other words, the cores 310 #1 to 310 #n cannot see the address range “0x10000000-0x1000FFFF”.

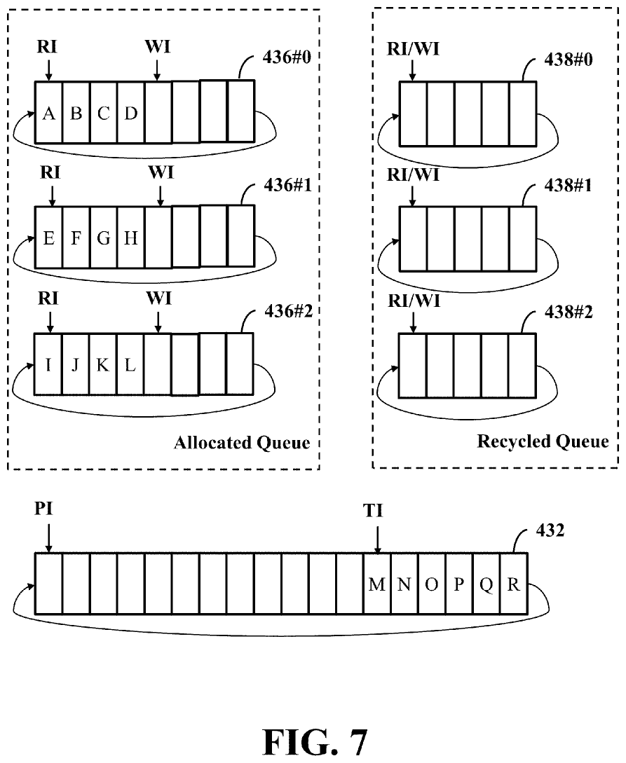

Refer to the initial states as shown in FIG. 4. All slots of the shared resource pool 432 store the items “A”, “B” “C”, “D”, “E”, “CF”, “G”, “H”, “I”, “J”, “K”, “L”, “M”, “N”, “N”, “O”, “P” “Q” and “R”, where the take index TI and the put index PI point to the slot storing the item “A”, and the read index RI and the write index WI of each of the allocated queues 436 #0, 436 #1 and 436 #2 point to the first slot thereof. Subsequently, refer to FIG. 7 showing a schematic diagram for initializing the proxy mechanism. Three allocation events are triggered to cause the allocation event handler 526 to migrate the items “A”, “B”, “C” and “D” in the shared resource pool 432 to the allocated queue 436 #0, migrate the items “E”, “F”, “G” and “H” in the shared resource pool 432 to the allocated queue 436 #1, and migrate the items “I”, “J”, “K” and “L” in the shared resource pool 432 to the allocated queue 436 #2. The updated take index TI of the shared resource pool 432 points to the slot storing the item “M”. The updated write index WI of the allocated queue 436 #0 points to the slot next to the slot storing the item “D”. The updated write index WI of the allocated queue 436 #1 points to the slot next to the slot storing the item “H”. The updated write index WI of the allocated queue 436 #2 points to the slot next to the slot storing the item “L”.

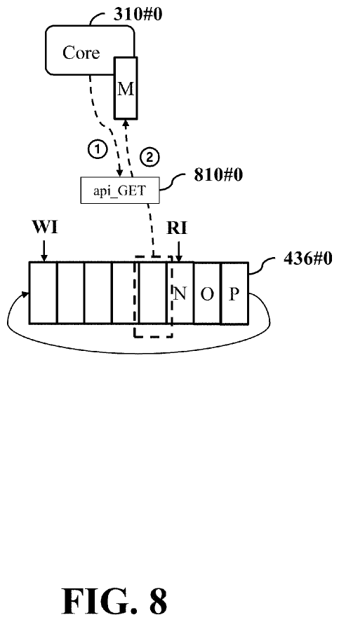

When any core needs more space of the RAM 330 to access data, the core fetches one or more items from its belonging allocated queue through the API “api_GET”. After that, the core can freely store data in the designated address range(s) of the RAM 330 indicated by the item(s), and read data from the designated address range(s) of the RAM 330. Through the configuration of the allocated queues 436 #0 to 436 #n with the operations of the allocation event handler 526, each core can access to the address ranges of the RAM 330, which is independent of the address ranges of the RAM 330 that can be accessed by the other cores. The data access by each core to the RAM 330 does not affect other cores, so that unnecessary waiting time caused by the aforementioned lock mechanism would be avoided. Refer to FIG. 8 showing an example for obtaining a memory address range. The process running on the core 310 #0 requests for an available range of memory address through the API “api_GET”. The module corresponding to the API “api_GET” fetches the item “M” from the allocated queue 436 #0 and replies with the item “M” to the core 310 #0 after receiving the request, so that the process running on the core 310 #0 can freely access to the memory address range recorded in the item “M”. The read index RI is updated from pointing to the fifth slot with pointing to the sixth slot.

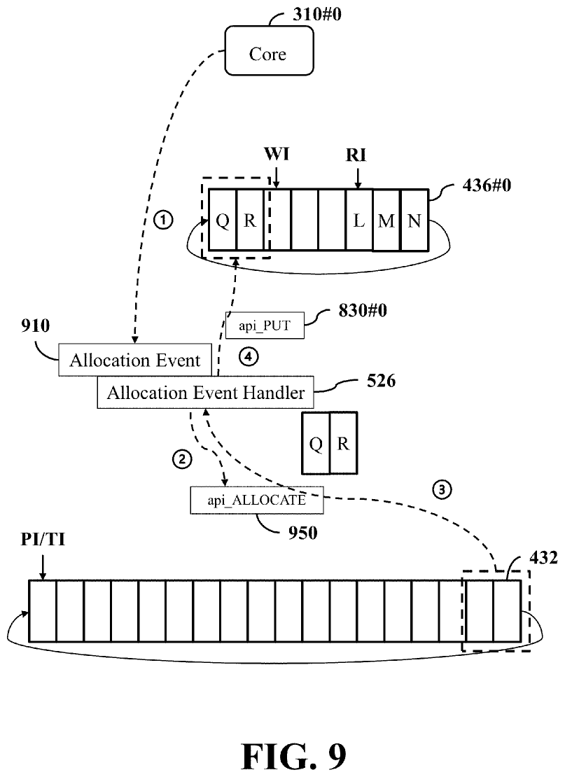

As more and more processes are running on a core, the allocated memory address range stored in the corresponding allocated queue may not be enough to support the execution of the processes. In this regard, refer to FIG. 9 showing an example for requesting to allocate memory address ranges. The process running on the core 310 #0 triggers the allocation event 910 to request the proxy module 500 to assign two items when detecting that the amount of items stored in the allocated queue 436 #0 is lower than a threshold (for example, the threshold may be set to the half of the total number of slots of the allocated queue 436 #0). In response to the allocation event 910, the allocation event handler 526 obtains the ID of the core 310 #0 and the requested number of items (step S610) and determines the allocated queue 436 #0 according to the ID of the core 310 #0 (step S620). The allocation event handler 526 fetches the items “Q” and “R” from the shared resource pool 432 through the API “api_ALLOCATE” and pushes the items “Q” and “R” into the allocated queue 436 #0 through the API “api_PUT” 830 #0 corresponding to the core 310 #0 (step S630). The take index TI is updated from pointing to the last second slot of the shared resource pool 432 with pointing to the first slot thereof. The write index WI is updated from pointing to the first slot of the allocated queue 436 #0 with pointing to the third slot thereof.

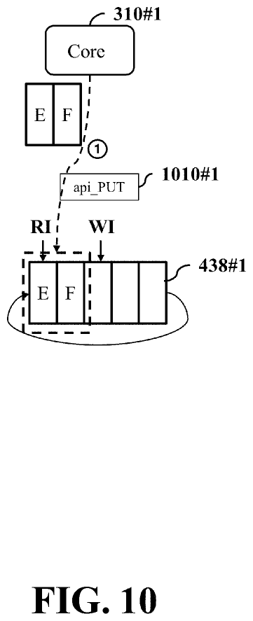

In order to optimize the usage of memory space, when any core does not need to use the fetched memory address range in the RAM 330, the core pushes the specific item indicating the fetched memory address range into the belonging recycled queue to release it through the API “api_PUT”. Refer to FIG. 10 showing an example for releasing memory address ranges. The process running on the core 310 #1 requests to take back the items “E” and “F” through the API “api_PUT”. The module corresponding to the API “api_PUT” pushes the items “E” and “F” into the recycled queue 438 #1 after receiving the request. The write index WI is updated from pointing to the first slot with pointing to the third slot.

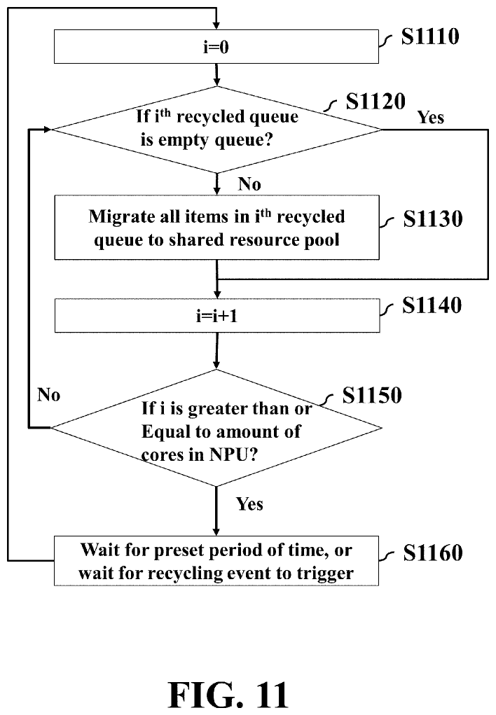

The proxy module 500 centrally takes back the shared storage resources from multiple cores 310 #0 to 310 #n in the NPU 310, where n is an amount of cores minus one. The proxy module 500 includes the recycling event handler 527 (as shown in FIG. 5). In response to the requirement for recycling the shared storage resources, the proxy module 500 provides a recycling event that can be triggered by any other process of the proxy module 500. In alternative embodiments, any of the cores 310 #0 to 310 #n executes a monitoring process to obtain the items stored in the corresponding recycled queue. The monitoring process triggers the recycling event when detecting that the items stored in the corresponding recycled queue exceeds a threshold (for example, the half of the total number of slots of the corresponding recycled queue). The CPU 320 when detecting the recycling event executes program code of the recycling event handler 527 to migrate all items in the recycled queues 438 #0 to 438 #n to the empty slots in the shared resource pool 432 through the APIs “api_GET” and “api_FREE”, which means to take back the designated space in the RAM 330 from the cores 310 #0 to 310 #n. Refer to FIG. 11 illustrating a method for recycling memory space, performed by the CPU 320 when loading and executing program code of the recycling event handler 527. The method includes an outer loop (steps S1110 to S1160) that is repeatedly executed to reclaim the allocated memory space. The outer loop includes an inner loop (steps S1120 to S1150) that is repeatedly executed to collect the memory spaces that have been allocated to one designated core from the corresponding recycled queue one by one. The details are as follows:

Step S1110: The variable i is set to 0. The variable i is used to record the number of the recycled queue currently being processed.

Step S1120: It is determined whether the i^{th} recycled queue is an empty queue. If so, the process proceeds to step S1140. Otherwise, the process proceeds to step S1130.

Step S1130: All items in the i^{th} recycled queue are migrated to the shared resource pool 432. For example, all items in the recycled queue are fetched through the API “api_GET”, and the fetched items are pushed into the empty slots of the shared resource pool 432 sequentially through the API “api_FREE”.

Step S1140: The variable i is increased by one.

Step S1150: It is determined whether the variable i is greater than or equal to the amount of cores in the NPU 310. If so, the process proceeds to step S1160. Otherwise, the process proceeds to step S1120. If the variable i is greater than or equal to the amount of cores in the NPU 310, it means that all recycled queues become empty queues.

Step S1160: Wait for a preset period of time, or wait for a recycling event to trigger. In some embodiments, the recycling event handler 527 may setup a timer to count to the preset period of time. The recycling event is triggered when the timer has counted to the preset time period. In alternative embodiments, the recycling event handler 527 may wait for the recycling event that is triggered by the executed monitoring process in any of the cores 310 #0 to 310 #n.

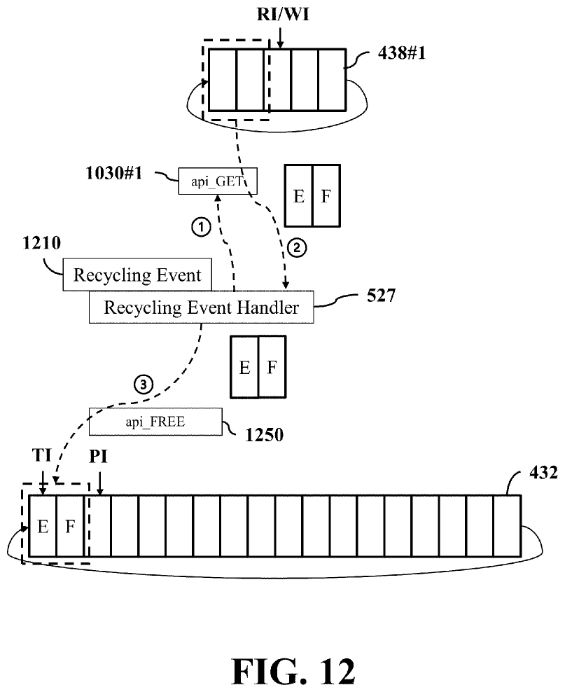

Refer to FIG. 12 showing an example for recycling memory address ranges that have been allocated. The recycling event handler 527 fetches the items “E” and “F” from the recycled queue 438 #1 through the API “api_GET” 1030 #1 and pushes the items “E” and “F” into the empty slots of the shared resource pool 432 sequentially through the API “api_FREE” 1250 when the recycling event is triggered (step S1130). The read index RI is updated from pointing to the first slot of the recycled queue 438 #1 with pointing to the third slot of the recycled queue 438 #1. The put index PI is updated from pointing to the first slot of the shared resource pool 432 with pointing to the third slot of the shared resource pool 432.

Some or all of the aforementioned embodiments of the method of the invention may be implemented in a computer program, such as a driver of a dedicated hardware, an application in a specific programming language, or others. Other types of programs may also be suitable, as previously explained. Since the implementation of the various embodiments of the present invention into a computer program can be achieved by the skilled person using his routine skills, such an implementation will not be discussed for reasons of brevity. The computer program implementing some or more embodiments of the method of the present invention may be stored on a suitable computer-readable data carrier, or may be located in a network server accessible via a network such as the Internet, or any other suitable carrier.

A computer-readable storage medium includes volatile and non-volatile, removable and non-removable media implemented in any method or technology for storage of information such as computer-readable instruction, data structures, program modules, or other data. A computer-readable storage medium includes, but is not limited to, RAM, ROM, EEPROM, flash memory or other memory, CD-ROM, digital versatile disks (DVD), Blue-ray disk or other optical storage, magnetic cassettes, magnetic tape, magnetic disk or other magnetic storage devices, or any other medium which can be used to store the desired information and may be accessed by an instruction execution system. Note that a computer-readable medium can be paper or other suitable medium upon which the program is printed, as the program can be electronically captured via, for instance, optical scanning of the paper or other suitable medium, then compiled, interpreted, or otherwise processed in a suitable manner, if necessary, and then stored in a computer memory.

Although the embodiment has been described as having specific elements in FIGS. 2 to 3, it should be noted that additional elements may be included to achieve better performance without departing from the spirit of the invention. Each element of FIGS. 2 to 3 is composed of various circuitries and arranged to operably perform the aforementioned operations. While the process flows described in FIGS. 6 and 11 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for memory access control, performed by a central processing unit (CPU), wherein the CPU is coupled to a network processing unit (NPU) and the NPU comprises a plurality of cores, the method comprising:
obtaining an identification of a first core, wherein the first core requests to allocate memory space;
determining a first allocated queue from a plurality of allocated queues according to the identification of the first core; and
dequeuing one or more first items in a shared resource pool starting from a slot that is pointed to by a take index, and enqueuing the one or more first items into the first allocated queue starting from an empty slot that is pointed to by a write index, wherein each first item comprises a memory address range of a random access memory (RAM), so that the memory address range of the RAM has been reserved for the first core.

2. The method of claim 1, wherein the shared resource pool is a cyclical queue, and memory address ranges of any two of all available items in the shared resource pool are not overlapped.

3. The method of claim 1, wherein the first core after dequeuing any first item from the first allocated queue through a first application programming interface (API) stores data in or reads data from the memory address range of the RAM, which is recorded in the dequeued first item.

4. The method of claim 1, comprising:
enqueuing second items of a plurality of recycled queues into empty slots of the shared resource pool,
wherein each second item comprises a memory address range that has been allocated for one corresponding core in the NPU.

5. The method of claim 4, wherein a second core enqueues a corresponding second item into a corresponding recycled queue through a second API when the second core does not need to use a memory address range of the RAM, which has been fetched previously.

6. The method of claim 4, wherein a recycling event handler comprises an operation for enqueuing the second items of the plurality of recycled queues into the shared resource pool, the method comprising:
executing the recycling event handler when a recycling event is triggered.

7. The method of claim 1, wherein an allocation event handler comprises a first operation for obtaining the identification of the first core, a second operation for determining the first allocated queue, a third operation for dequeuing the one or more first items from the shared resource pool, and a fourth operation for enqueuing the one or more first items into the first allocated queue, the method comprising:
executing the allocation event handler when an allocation event is triggered.

8. An optical network unit (ONU) router, comprising:
a network processing unit (NPU), comprising a plurality of cores;
a random access memory (RAM), coupled to the NPU, comprising a shared resource pool and a plurality of allocated queues; and
a central processing unit (CPU), coupled to the NPU and the RAM, arranged operably to: obtain an identification of a first core from the first core of the NPU, wherein the first core requests to allocate memory space; determine a first allocated queue from a plurality of allocated queues according to the identification of the first core; and dequeue one or more first items in the shared resource pool starting from a slot that is pointed to by a take index, and enqueue the one or more first items into the first allocated queue starting from an empty slot that is pointed to by a write index, wherein each first item comprises a memory address range of the RAM, so that the memory address range of the RAM has been reserved for the first core.

9. The ONU router of claim 8, wherein the shared resource pool is a cyclical queue, and memory address ranges of any two of all available items in the shared resource pool are not overlapped.

10. The ONU router of claim 8, wherein the first core after dequeuing any first item from the first allocated queue through a first application programming interface (API) stores data in or reads data from the memory address range of the RAM, which is recorded in the dequeued first item.

11. The ONU router of claim 8, wherein the CPU is arranged operably to: enqueue second items of a plurality of recycled queues into empty slots of the shared resource pool, wherein each second item comprises a memory address range that has been allocated for one corresponding core in the NPU.

12. The ONU router of claim 11, wherein a second core enqueues a corresponding second item into a corresponding recycled queue through a second API when the second core does not need to use a memory address range of the RAM, which has been fetched previously.

13. The ONU router of claim 11, wherein a recycling event handler comprises an operation for enqueuing the second items of the plurality of recycled queues into the shared resource pool, and the CPU is arranged operably to: execute the recycling event handler when a recycling event is triggered.

14. The ONU router of claim 8,
wherein an allocation event handler comprises a first operation for obtaining the identification of the first core, a second operation for determining the first allocated queue, a third operation for dequeuing the one or more first items from the shared resource pool, and a fourth operation for enqueuing the one or more first items into the first allocated queue,
wherein the CPU is arranged operably to: execute the allocation event handler when an allocation event is triggered.

15. A method for memory access, applied in a multi-core network processing unit (NPU), wherein the multi-core NPU comprises a first core and a second core, the method comprising:
in response to the first core requesting memory space allocation, providing a first item from a first allocated queue dedicated to the first core to the first core, wherein the first allocated queue cannot be used by the second core; and
accessing, by the first core, to memory space indicated by a first memory address range recorded in the first item.

16. The method of claim 15, comprising:
in response to an allocation event, fetching the first item from a shared resource pool; and
pushing the first item into the first allocated queue.

17. The method of claim 16, wherein the shared resource pool comprises a plurality of third items and each third item stores a third memory address range that can be reserved for any of the first core and the second core.

18. The method of claim 15, comprising:
in response to the first core requesting to release memory space, pushing a second item that has been provided to the first core to use into a first recycled queue dedicated to the first core,
wherein a second memory address range recorded in the second item that is pushed into the first recycled queue is no longer used by the first core, and
wherein the first recycled queue cannot be used by the second core.

19. The method of claim 18, comprising:
in response to a recycling event, migrating the second item in the first recycled queue to an empty slot of a shared resource pool.

20. The method of claim 19, wherein the second memory address range stored in the shared resource pool can be reserved for any of the first core and the second core.
